(19) United States
(12) Patent Application Publication
(10) Pub. No.: US 2003/0046433 A1
(43) Pub. Date: Mar. 6, 2003

(54) Method to synchronize information between online devices

(76) Inventors: Omer Luzzatti, New York, NY (US); Ofer Shem Tov, Ramat Gan (IL); Eran Shtiegman, New York, NY (US); Gur Kimchi, New York, NY (US); Dror Tirosh, Raanana (IL)

Correspondence Address: KATTEN MUCHIN ZAVIS ROSENMAN, 575 MADISON AVENUE, NEW YORK, NY, 10022-2585, US

(21) Appl. No.: 09/915,215

(22) Filed: Jul. 25, 2001

(51) Int. Cl. G06F 15/16

(52) U.S. Cl. 709/248

(57) ABSTRACT

A synchronization method for communication devices via various interfaces such as the web, networked clients, or cellular devices that support WAP or other devices such as PSTN or mobile telephones. Synchronization is performed by the device originating the event sending a request verb indicating the required event to the server. The server sends back an acknowledgment (response) verb to that particular device and an addition verb about the event to all of the subscriber's connected devices (this list includes the device that originated the event if this device is of a type that receives server originated events). A sync maintenance embodiment monitors each device, and when a device is determined to have become unsynchronized, a repair procedure is initiated using status identifiers kept on the devices (Local Status Identifiers) and on the server (Master Status Identifiers) that are sent periodically to the server.

### BACKGROUND OF THE INVENTION

### FIELD OF INVENTION

The present invention relates generally to the field of synchronization of communication devices to remote servers and associated databases. More specifically, the present invention is related to network based synchronization of a server system and a single communication device and, for a group of devices, information commonly shared.

A subscriber who uses one or more devices to access Internet communications services may perform many services such as: making a call, sending messages, altering their contact list, changing their current routing policies (i.e., affect the way calls will be routed to them), etc. In some scenarios, a subscriber is allowed to have more than one active device simultaneously and thus must provide synchronization for information shared by the group of devices as well as maintain and/or repair synchronization (i.e., errors based on packet loss, etc.) for each individual device. In such situations, synchronization between the subscriber's device(s) and a remote server system and associated device data is required. The prior art, however, has failed to provide a method by which such synchronization can be established and maintained.

For example, when one subscriber sends a message to another subscriber who has two active devices (e.g., PC clients), not only should both devices (clients) indicate about the incoming message (using e.g. a flashed icon), but that whenever the subscriber actually reads the message using one of their clients, the indication about the incoming message should disappear (e.g. stop flashing) from the second device.

The first problem here is how to maintain the synchronization of all devices when operations are made using one device. An example would be: if a subscriber adds a contact to their address book using one device, how to make sure all other devices address books are updated.

The second problem to deal with is how to detect an out-of-sync scenario and how to bring the system back to synchronization in such a case. Moreover, the detection and correction of out-of-sync status should be done in an efficient way. An example would be: if, for some reason (such as packet loss, loosing network connection during operations, etc.) an update hasn't arrived to the device and the device doesn't have the right address book, how to detect the problem and how to bring the device back to synchronization with the server.

### SUMMARY OF THE INVENTION

The present invention offers a system and method that enable a subscriber to communicate and control their communication devices via various interfaces such as the web, networked clients, cellular devices that support WAP or regular PSTN phones. As in other messenger clients (such as AOL Instant Messenger®, Yahoo Messenger®, MSN®, etc.), the subscriber can manage their contact list (adding, deleting, editing contacts) and send messages. In addition, they can place a call and change their routing policy. However, in the present invention service (unlike some other prior art IM clients), the subscriber can be connected to the system from more than one device, and thus can perform operations with one device that will affect other devices. The system maintains the synchronization of information (contact lists, etc.) associated with the devices (subscriber/owners of the devices) and makes sure the device remains in sync even in rough network conditions (such as packet loss). In particular, the present invention provides synchronization of the following events (but not limited thereto):

1) Address Book—Whenever a change to the contact list (Address book) is done using one device (or automatically—e.g. the system adds a default contact), all connected devices should be notified. Examples of possible events are: adding a contact, editing a contact's name, and deleting a contact.

2) Messages—Whenever a change is made to a message status using one device (or automatically, e.g. sending a system message such as missed call), all connected devices should be notified. The possible events are: reading a new message (thus changing its status from ‘new’ to ‘read’), and deleting a message. This includes system messages that are sent automatically by the system and missed called messages that are sent after an unsuccessful call attempt.

3) Policy—Whenever a change is made to the list of subscriber routing policies or to the current active routing policy using one device, all other devices should be notified. The possible events are: adding or deleting a policy, changing the current active policy. The routing policy defines how an incoming communication (such as a call) is to be routed. Subscribers are able to maintain one or more policies corresponding to one or more contacts or groups of contacts that selectively handle a communication based on their identity. For example, if subscribers L and M initiate a communication to subscriber N, and subscriber N utilizes two communication devices, device 1 and device 2, to receive such communications, the system of the present invention allows subscriber N to maintain two separate policies, one each for subscribers L and M, regarding how the incoming communication is to be handled. In other words, a routing policy allows subscriber N to selectively handle communications between subscribers L and/or M for via device 1 and/or device 2 based on subscriber-based pre-defined customizable policies. A detailed description of the routing policy used in the present invention is given in U.S. patent application Ser. No. 08/780,739, which is hereby incorporated by reference.

For synchronization, the device originating the event sends a message indicating the required event to the server. The server sends back an acknowledgment verb to that particular device and a message about the event to all of the subscriber's connected devices (this list may include the device that originated the event). Only when a device receives a server originated message indicating about the event, the event is considered complete and the device may act accordingly (such as adding the contact to the contact list).

In addition, the system uses status identifiers kept on the devices (Local Status Identifiers) and on the server (Master Status Identifiers) that are sent periodically to the server. These identifiers enable the server to detect any out-of-sync device and to update it accordingly.

### BRIEF DESCRIPTION OF THE DRAWINGS

FIG. 1 illustrates the architecture of the present invention.

FIG. 2 illustrates a flow diagram of the present invention synchronization method.

FIG. 3 illustrates a flow diagram of an extension to present invention synchronization method.

FIG. 4 illustrates a message implementation of the present invention.

FIG. 5 illustrates out-of-sync detection during device login.

FIG. 6 illustrates periodic “keep-alive” verbs,

FIG. 7 illustrates a table of status identifiers for an address book.

FIG. 8 illustrates a table of status identifiers for messages.

FIG. 9 illustrates an example of devices connected to the present invention synchronization system (server).

### DESCRIPTION OF THE PREFERRED EMBODIMENTS

While this invention is illustrated and described in a preferred embodiment, the device may be produced in many different configurations, forms and materials. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention. In the preferred embodiment the front end, back end and databases are located in a subscriber server system; however, in alternative embodiments, the parts of the system are distributed across the network (such as the Internet), but remain operative using the method of the present invention.

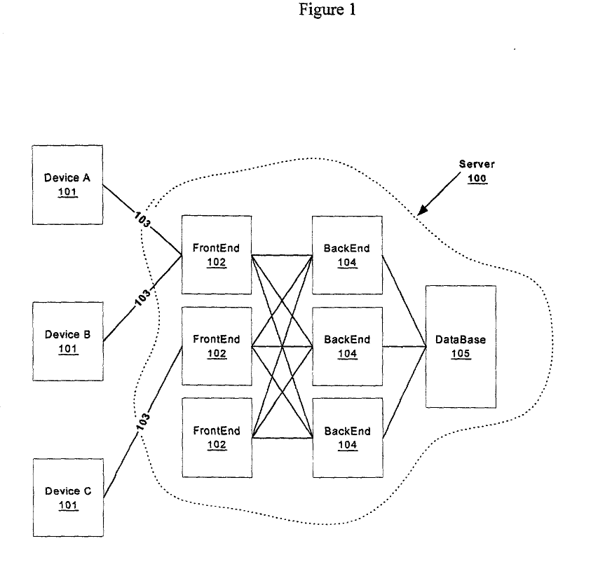

Referring to FIG. 1, all the information is being maintained centrally in a web connected server 100 or more specific in a subscriber database contained therein. The server 100 is a combination of three layers: front ends (FEs) 102 that receive and maintain the connections 103 to the devices 101, back ends (BEs) 104 that perform the system logic and a database (DB) 105 that keeps all of the information needed for the system operation (or in an alternative embodiment, more than one DB is part of the ‘server’ and a synchronization method between the DBs exists). Unlike in other IM clients (such as ICQ), the DB maintains all of the subscriber's information such as the address book, the policies, the messages, the calls, etc. . . . The fact that the DB maintains all the accurate information of the subscribers, enables that the required synchronization between all the devices can be achieved, if only all the devices are synchronized with the centralized DB. The required synchronization than is: how to maintain synchronization between the devices and the DB and how to detect if one device is out of sync and bring it back to sync.

Maintaining Synchronization Between Devices

General

A device originating an event 101 sends a request verb indicating the required event to the server 100. The server sends back an acknowledgment (response) verb to that particular device and an addition verb about the event to all of the subscriber's connected devices (this list includes the device that originated the event if this device is of a type that receives server originated events). Only when a device receives a server originated verb indicating about the event, the event is considered complete and the device may act accordingly (such as adding the contact to the contact list).

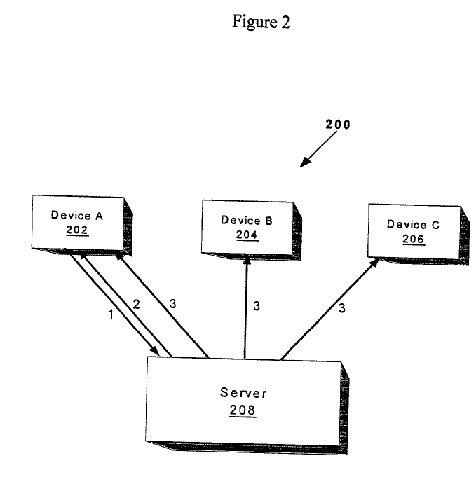

Devices that have a Connection to the Server—200 (FIG. 2)

Referring to FIG. 2, devices A, B and C (202, 204 and 206, respectively) are connected to the server 208. Device A 202 sends (1) a request to the server 208 (such as ‘add a contact’), the server answers (2) with an acknowledgement response and then sends multiple orders (3) to the connected devices 204 and 206 ordering them about the event. Only when the connected devices receive the server-originated verbs, will the event is being acted upon by them (such as actually adding the contact to the list).

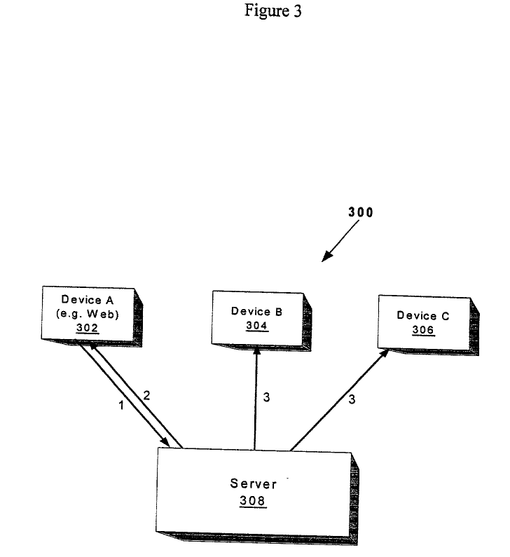

Events Originated from Devices that do not Receive Notifications—300 (FIG. 3)

In FIG. 2, the device originated the request (device A) is connected to the server and receives (like any other device) the server originated verbs (3). This may not be the case when the device originating the request does not have a permanent connection to the server such in the case of a Web.

In such cases, the flow is shown in FIG. 3. Device A 302 cannot receive server-originated verbs at all and devices B 304 and C 306 are connected to the server 308 (have a permanent connection to the server). Device A 302 sends (1) a request verb to the server 308 (such as ‘add a contact’), the server answers (2) with an acknowledgement response and then sends multiple orders (3) to the connected devices 304 and 306 ordering them about the event. As for device A, already when it receives the acknowledgement (2) it can follow the event order, as for client B and C, they will follow the event whenever they receive the server-originated order.

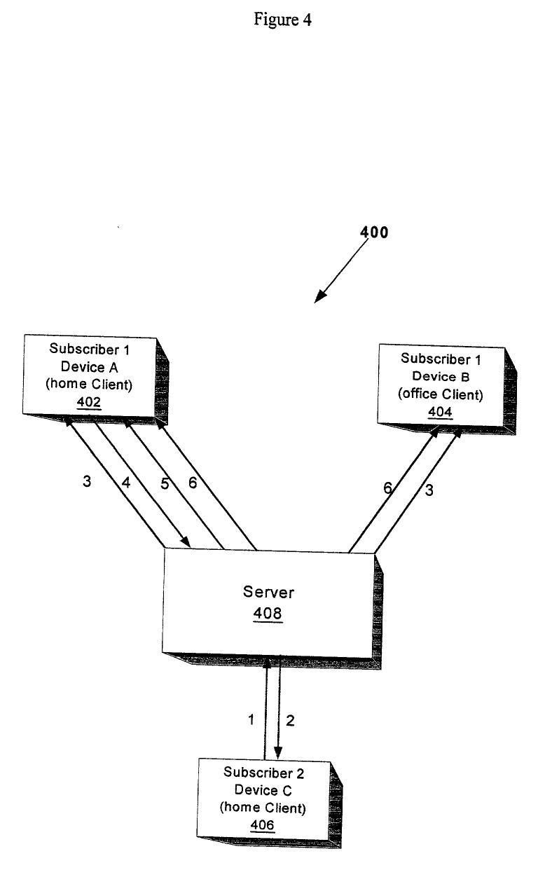

Specific Example—Sending Messages—400 (FIG. 4)

A more specific example can be made in order to further demonstrate this part of the invention and the way it is being used when a subscriber sends a message to another subscriber who has more than one connected device:

Subscriber 2 wants to send a message to subscriber 1. Using their Device C (e.g. their home TG Client) 406 he writes the message and sends it to the server 408 (1), the server responses in an acknowledge response (2) The server now sends (3) an indication about the new message to all of the connected devices of subscriber 1 (in our example devices A 402 and B 404). Although subscriber 1 is connected to the server from multiple locations (home—device A 402, office—device B 404) he decided to read this one from their device at home (A) 402, so he reads the message and sends (4) an indication to the server about the message new status (‘read’ instead of ‘new’). The server acknowledges (5) the status change and sends (6) an indication about the new status to all of the subscriber's connected devices A and B.

Using the above described method device B 404 received a first indication about the new message and then, after the message was read using device A 402, an indication about the message new status so it is impossible that the message will be regarded as ‘new’ if read in another device.

Out-of-sync Detection

General

It might happen, for various reasons such as packet loss, poor network performance, etc., that a device is not in sync with the DB (example—the address book is different). In such cases it's crucial to trace the problem as fast as possible and to correct it. The present invention solves the problem using status identifiers kept on the devices (Local Status Identifiers) and on the server (Master Status Identifiers) that are sent periodically to the server. These identifiers enable the server to detect any out-of-sync device and to update it accordingly.

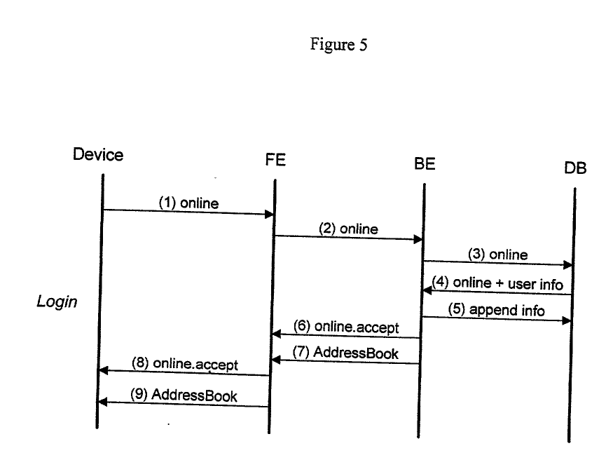

Login—FIG. 5

Referring to FIG. 5, whenever a device logs-in, a verb (request) of the type ‘online’ is being sent to the server FrontEnd (1); this verb contains the local status identifiers as follows:

a. Address Book: The hash (MD5) of the entire address book of the subscriber, including the names of the contacts and their alias names.

b. Messages: The (unique) ID of the last message the device received.

c. Policy: Binary data that was passed during the last policy modification.

The FE passes this online verb to the BE (2). The BE asks the DB for relevant information (3) and retrieves this information from the DB (4). The BE now compares the master status identifiers (stored in the DB or deduced from the DB information) to the local ones sent from the device (e.g., the hash of the contact list the device has and the hash of the contact list in the DB) and decides whether the device should be updated or not. The BE then updates the DB about the subscriber plus device new status (5) and sends back to the FE the needed parameters plus the status identifiers (to be kept in the FE)(6). In case the device status is not correct and accurate information should be sent to the device, the BE sends additional verbs to update the device (e.g., sending the address book (7)). The FE keeps the status identifications and sends the verbs to the device (8, 9). In case the status has changed, the device will recalculate the identifiers and will keep them.

In addition, the server sends back to the client the time between to keep alive verbs. A fixed time period can be used, but in a preferred embodiment a random generation of time periods is used. In addition, the server may order the client to send the local identifiers in every period of time using the periodical verbs described below.

Periodical Verbs

In order to detect a device that went out of sync, periodical verbs are sent from the devices to the server every certain time interval to be determined by the server (usually around 90 seconds). The time interval can be changed upon the service decision for reasons such as different network conditions (packet loss, delays) or server performance (server under stress will increase the time interval).

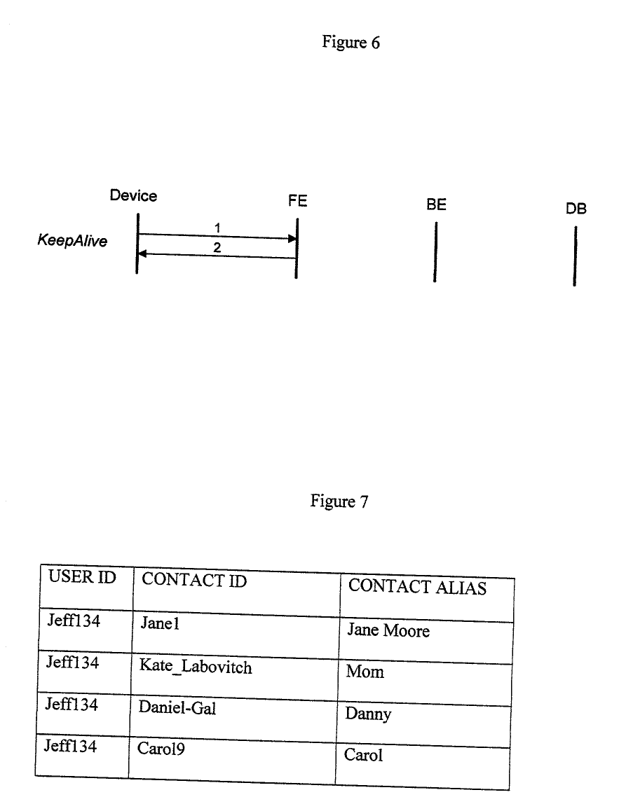

Referring to FIG. 6, the periodical verb sent from the devices contains the local status identifiers so that the FE can check if they are identical to the master status identifiers (1). Note that the BE notifies the FE of any change in the identifiers. If the server information (kept in the FE) is different than the one in the device, the FE will address the BE that will send the full needed information to the client. Otherwise, if the status identifiers are identical, the FE will send back to the device an acknowledgement (2).

Keeping a copy of the master status identifiers in the FE makes the system (the server) more efficient and more scalable in the sense that the BE is not involved in any periodical verb unless a synchronization is needed.

Status Identifiers Description

1) Address Book:

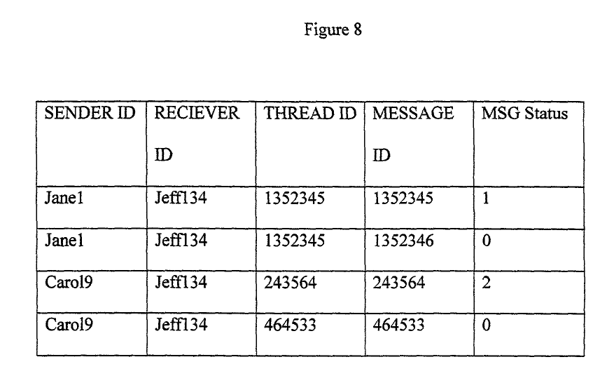

The table in FIG. 7 illustrates an example of the address book table for one subscriber whose UserID is Jeff 134:

The Address Book Status Identifier for this subscriber would equal the hash (MD5) of the string containing all the Contacts ID and their aliases:

AddressBook Status Identifier for Jeff134=

MD5(“Jane1JaneMooreKate_LebovitchMomDaniel-GalDannyCarol9Carol”).

The reason to use a Hash function is to make sure the identifier won't get longer than a certain amount of size (i.e., MD5 hashing will always result in 128 Bits).

2) Messages: (FIG. 8)

Referring to FIG. 8, the status identifier for messages is simply the MessageID of the last new message sent to the device. Message Status that appear in the table are as follows: 0—new message, 1—read message, 2—deleted message.

The example in the table shows 4 messages for Jeff134, two of them are new messages (numbers 1352346 and 464533) since the first one is newer, the Status Identifier for the Jeff s messages (i.e., the one he'll send to the server) is 1352346.

3) Policy

The policy status identifier is a cookie sent by the server to the client and can contain whatever information the server desires. As for the Policy synchronization logic:

the client saves the last cookie value returned from the server

the server sends a cookie on each policy (or mesg) operation

if the server sees the client's cookie is old, it sends a full info (either all policy names, or all pending unread messages) to the client

the new cookie is sent as part of the new info.

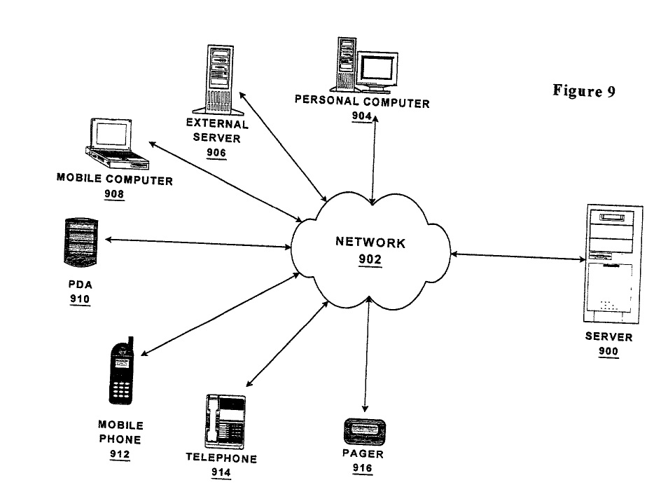

FIG. 9 illustrates a scenario wherein subscribers are able to access the server hosting the present invention's synchronization method over a network via a variety of communication devices. For example, a subscriber is able to access server 900 over network 902 via any of the following devices: personal computers 904, external server 906, mobile computers 908, personal digital assistant (PDA) 910, mobile phones 912, telephones 914, or pagers 916. It should however be noted that although only certain devices are illustrated as input/output devices in FIG. 9, one skilled in the art can envision substituting other communication devices in place of the devices illustrated. Network 902, described in the FIG. 9, and as used in this specification is any of, but not limited to, the following networks: local area network (LAN), wide area network (WAN), Internet, Wireless or cellular networks.

It should be noted that a variety of interfaces can be used in conjunction with the invention. For example, subscribers are able to initiate an event (answering message) via a cellular phone interface, wherein the cellular phone is wireless application protocol (WAP) enabled. Similarly, a dual tone multi-frequency (DTMF) telephone system can be used to query a subscriber's information (address book, contact list, etc.) stored and synchronized by the server. For example, one can call and inquire about their contact list and receive the most recently updated list in the same phone using an interactive voice response (IVR) feature or change their contact list and have the server synchronize this information for any devices sharing this information.

In one embodiment, subscribers with electronic messaging access are able to send a message (such as an email) querying the availability mode of another subscriber. In such a scenario, the ‘availability mode’ of the queried subscriber is also returned via an electronic message such as email.

In yet another embodiment, a graphical user interface (GUI) is used to request availability modes of a subscriber. In this scenario, icons representative of the availability mode of the queried subscriber are sent and displayed in requestor's GUI.

### CONCLUSION

A system and method has been shown in the above embodiments for the effective implementation of a method to synchronize information between online devices. While various preferred embodiments have been shown and described, it will be understood that there is no intent to limit the invention by such disclosure, but rather, it is intended to cover all modifications and alternate constructions falling within the spirit and scope of the invention, as defined in the appended claims. For example, the present invention should not be limited by software/program, computing environment, specific computing hardware and specific information synchronized.

The above enhancements and its described functional elements are implemented in various computing environments. For example, the present invention may be implemented on a conventional IBM PC or equivalent, multi-nodal system (e.g., LAN) or networking system (e.g. Internet, WWW, wireless web). All programming and data related thereto are stored in computer memory, static or dynamic, and may be retrieved by the subscriber in any of: conventional computer storage, display (i.e., CRT) and/or hardcopy (i.e., printed) formats. The programming of the present invention may be implemented by one of skill in the art of network and database programming.

1. A method of maintaining synchronization between a group comprising multiple communications devices, when information associated with the group is modified by one of said multiple devices, said method comprising:
receiving a request verb from a first device of said grouped multiple communications devices, said request verb indicating a required event to a remotely located server;
said server returning an acknowledging response verb to said first device;
said server sending a modifying verb indicating information about said required event to each remaining device in said group, and
when a remaining device receives said server originated modifying verb, the event is considered complete and the device performs said required event.

2. A method of maintaining synchronization between a group of multiple communications devices, as per claim 1, where said server additionally returns said modifying verb to said first device if it is capable of receiving server originated events.

3. A method of maintaining synchronization between a group of multiple communications devices, as per claim 1, where said required event comprises modification of a contact list to include any of: adding a contact, editing a contact, or deleting a contact.

4. A method of maintaining synchronization between a group of multiple communications devices, as per claim 1, where said required event comprises modification of a message status modified to include any of: reading a new message or deleting a message.

5. A method of maintaining synchronization between a group of multiple communications devices, as per claim 1, where said required event comprises modification of a routing policy modified to include any of: adding a policy, deleting a policy, or changing a current active policy.

6. A method of maintaining synchronization between a group of multiple communications devices, as per claim 1, wherein said synchronization method further comprises, for one or more devices in said group, detection and repair of an out-of-sync scenario between said device and said server.

7. A method of maintaining synchronization between a group of multiple communications devices, as per claim 6, wherein said out-of-sync scenario is created by any of: packet loss, loss of network connection during operations, or corruption of data.

8. A method of maintaining synchronization between a group of multiple communications devices, as per claim 6, wherein said detection and repair of an out-of-sync scenario comprises periodic receiving of verbs comprising a device status identifier by said server and returning of a modifying verb upon detection of an out-of-sync status.

9. A method of maintaining synchronization between a group of multiple communications devices, as per claim 8, wherein periodic verbs are received from said one or more devices at alterable time periods.

10. A method of maintaining synchronization between a group of multiple communications devices, as per claim 6, wherein said detection and repair of an out-of-sync scenario comprises, at device login:
receiving a device generated verb request;
comparing server master status identifiers to said device status identifier to determine if a modification is required;
if required, returning a modifying verb.

11. A method of maintaining synchronization between a group of multiple communications devices, as per claim 10, wherein said online verb comprises:
a hash of an address book of a device subscriber;
an ID of a last message the device received, and binary data passed to said device during a policy modification required event.

12. A method of synchronization one or more communication devices with a remote server system, said remote server system comprising one or more databases and one or more servers located locally or remotely, said method comprising:
for each of said communication devices:
detecting and repairing of an out-of-sync scenario between said device and said server system, said detecting step comprising periodically receiving verbs at said server system comprising a device status identifier and returning a modifying verb upon detection of an out-of-sync status;
for a group of said communication devices sharing information in said one or more databases:
receiving a request verb from a first device of said grouped communications devices, said request verb indicating a required event to said remotely located server system;
said server system returning an acknowledging response verb to said first device;
said server system sending a modifying verb indicating information about said required event to each remaining device in said group, and
when a remaining device receives said server originated modifying verb, the event is considered complete and the device performs said required event.

13. A method of synchronization one or more communication devices with a remote server system, as per claim 12, wherein said out-of-sync scenario is created by any of: packet loss, loss of network connection during operations, or corruption of data.

14. A method of synchronization one or more communication devices with a remote server system, as per claim 12, wherein said periodic verbs are received from said one or more devices at alterable time periods.

15. A method of synchronization one or more communication devices with a remote server system, as per claim 12, wherein said detection and repair of an out-of-sync scenario comprises, at device login:
receiving an online verb request;
comparing server system master status identifiers to said device status identifier to determine if a modification is required;
if required, returning a modifying verb.

16. A method of synchronization one or more communication devices with a remote server system, as per claim 15, wherein said online verb comprises:
a hash of an address book of a device subscriber;
an ID of a last message the device received, and.

17. A method of synchronization one or more communication devices with a remote server system, as per claim 12, where said server system additionally returns said modifying verb to said first device if it is capable of receiving server originated events.

18. A method of synchronization one or more communication devices with a remote server system, as per claim 12, where said required event comprises modification of a contact list to include any of: adding a contact, editing a contact, or deleting a contact.

19. A method of synchronization one or more communication devices with a remote server system, as per claim 12, where said required event comprises modification of a message status modified to include any of: reading a new message or deleting a message.

20. A method of synchronization one or more communication devices with a remote server system, as per claim 12, where said required event comprises modification of a routing policy modified to include any of: adding a policy, deleting a policy, or changing a current active policy.

21. A remote server system for synchronization with one or more communication devices, said remote server system comprising one or more elements located together or distributed across a network, said system comprising:
one or more front end processing elements;
one or more back end processing elements operatively connected to said one or more front end processing elements;
one or more databases operatively connected to said one or more back end processing elements;
interface means operative with said front end processing elements to receive and transmit event verbs to one or more communications devices;
detecting and repairing software operative with said front and back end processing elements, said detecting and repairing software, for each of said communications devices:
detecting and repairing an out-of-sync scenario between said device and said remote server system, said detecting comprising periodically receiving said verbs at said server system comprising a device status identifier and returning a modifying verb upon detection of an out-of-sync status;
synchronization software, said synchronization software operative with said front and back end processing elements, for grouped communication devices sharing information in said one or more databases:
receiving a request verb from a first device of said grouped communications devices, said request verb indicating a required event to said remotely located server system;
said server system returning an acknowledging response verb to said first device;
said server system sending a modifying verb indicating information about said required event to each remaining device in said group, and
when a remaining device receives said server originated modifying verb, the event is considered complete and the device performs said required event.

22. A remote server system for synchronization with one or more communication devices, as per claim 21, where said one or more databases store one or more of specific device: address book(s), messages and policies.

23. A remote server system for synchronization with one or more communication devices, as per claim 21, where said status identifier comprises at least one or a combination of: address book status identifiers, message status identifiers and policy status identifiers.

24. A remote server system for synchronization with one or more communication devices, as per claim 21, where said address book status identifiers are equal to the hash of a string containing all contacts ID and their aliases, said message status identifier comprises a MessageID of the last new message sent to the device and the policy status identifier is a cookie sent by the server system to the device and comprises customized information.
